(19) United States
(12) Patent Application Publication
(10) Pub. No.: US 2018/0121791 A1
(43) Pub. Date: May 3, 2018

(54) TEMPORAL DIFFERENCE ESTIMATION IN AN ARTIFICIAL NEURAL NETWORK

(71) Applicant: QUALCOMM Incorporated, San Diego, CA (US)

(72) Inventors: Peter O'CONNOR, Amsterdam (NL); Max WELLING, Bussum (NL)

(21) Appl. No.: 15/590,609

(22) Filed: May 9, 2017

Related U.S. Application Data
(60) Provisional application No. 62/417,224, filed on Nov. 3, 2016.

(51) Int. Cl. G06N 3/04

(52) U.S. Cl. CPC G06N 3/049

(57) ABSTRACT

A method of computation in a deep neural network includes discretizing input signals and computing a temporal difference of the discrete input signals to produce a discretized temporal difference. The method also includes applying weights of a first layer of the deep neural network to the discretized temporal difference to create an output of a weight matrix. The output of the weight matrix is temporally summed with a previous output of the weight matrix. An activation function is applied to the temporally summed output to create a next input signal to a next layer of the deep neural network.

### CROSS-REFERENCE TO RELATED APPLICATION

The present application claims the benefit of U.S. Provisional Patent Application No. 62/417,224, filed on Nov. 3, 2016, and titled “TEMPORAL DIFFERENCE ESTIMATION IN AN ARTIFICIAL NEURAL NETWORK,” the disclosure of which is expressly incorporated by reference herein in its entirety.

### BACKGROUND

### Field

Certain aspects of the present disclosure generally relate to machine learning and, more particularly, to improving systems and methods for using a temporal difference of objects in sequential data for computations with an artificial neural network.

### Background

An artificial neural network, which may comprise an interconnected group of artificial neurons (e.g., neuron models), is a computational device or represents a method to be performed by a computational device.

The artificial neural network may be specified to perform computations on sequential data, such as a video. The computations may include extracting features and/or classifying objects in the sequential data. The extracted features and/or classification may be used for object tracking. The object tracking may be used for various applications and/or devices, such as internet protocol (IP) cameras, Internet of Things (IoT) devices, autonomous vehicles, and/or service robots. The applications may include improved or more computationally efficient object perception and/or understanding an object's path for planning.

Sequential data, such as temporal data (e.g., video), may be temporally redundant. That is, neighboring frames may be similar. In conventional systems, an artificial neural network, such as an artificial neural network used for deep learning, processes each frame of the temporal data with a convolutional network. The output of the convolutional network (e.g., extracted features) may be received at a recurrent architecture.

Processing each frame of the temporal data with a convolutional network may increase the use of resources in a device. That is, the amount of processing resources used in conventional systems is independent of the data content. It is desirable to reduce the number of processing resources by exploiting the similarities of neighboring frames.

### SUMMARY

In an aspect of the present disclosure, a method of computation in a deep neural network is presented. The method includes discretizing first input signal and a second input signal and computing a temporal difference of the first input signal and the discrete second input signal to produce a discretized temporal difference. The method also includes applying weights of a first layer of the deep neural network to the discretized temporal difference to create an output of a weight matrix. In addition, the method includes temporally summing the output of the weight matrix with a previous output of the weight matrix. The method further includes applying an activation function to the temporally summed output to create a next input signal to a next layer of the deep neural network.

In another aspect of the present disclosure, an apparatus for computation in a deep neural network is presented. The apparatus includes a memory and one or more processors coupled to the memory. The processor(s) is(are) configured to discretize first input signal and a second input signal and to compute a temporal difference of the discrete first input signal and the discrete second input signal to produce a discretized temporal difference. The processor(s) is(are) also configured to apply weights of a first layer of the deep neural network to the discretized temporal difference to create an output of a weight matrix. In addition, the processor(s) is(are) configured to temporally sum the output of the weight matrix with a previous output of the weight matrix. The processor(s) is(are) further configured to apply an activation function to the temporally summed output to create a next input signal to a next layer of the deep neural network.

In yet another aspect of the present disclosure, an apparatus for computation in a deep neural network is presented. The apparatus includes means for discretizing first input signal and a second input signal and computing a temporal difference of the discrete first input signal and the discrete second input signal to produce a discretized temporal difference. The apparatus also includes means for applying weights of a first layer of the deep neural network to the discretized temporal difference to create an output of a weight matrix. In addition, the apparatus includes means for temporally summing the output of the weight matrix with a previous output of the weight matrix. The apparatus further includes means for applying an activation function to the temporally summed output to create a next input signal to a next layer of the deep neural network.

In still another aspect of the present disclosure, a non-transitory computer readable medium is presented. The non-transitory computer readable medium has encoded thereon program for computation in a deep neural network. The program code is executed by a processor and includes program code to discretize first input signal and a second input signal and to compute a temporal difference of the discrete first input signal and the discrete second input signal to produce a discretized temporal difference. The program code also includes program code to apply weights of a first layer of the deep neural network to the discretized temporal difference to create an output of a weight matrix. In addition, the program code includes program code to temporally sum the output of the weight matrix with a previous output of the weight matrix. The program code further includes program code to apply an activation function to the temporally summed output to create a next input signal to a next layer of the deep neural network.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6 is a block diagram illustrating exemplary neural network architectures in accordance with aspects of the present disclosure.

FIG. 7 illustrates a method for feature extraction according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Temporal Difference Estimation in an Artificial Neural Network

Deep neural networks may be wasteful when processing temporally redundant inputs, such as video. That is, the network may expend a fixed amount of computation for each frame with no regard to the similarity between neighboring frames. As a result, the deep neural network repeatedly performs very similar computations. Aspects of the present disclosure are directed to configuring a Sigma-Delta network to improve utilization and efficiency of computational resources and to reduce computational costs.

In accordance with aspects of the present disclosure, the deep neural network configured as a Sigma-Delta network sends a discretized form of the change in activation to a next layer of the network for each new input. Thus, the amount of computation performed by the network scales with the amount of change in the input and layer activations, rather than the size of the network.

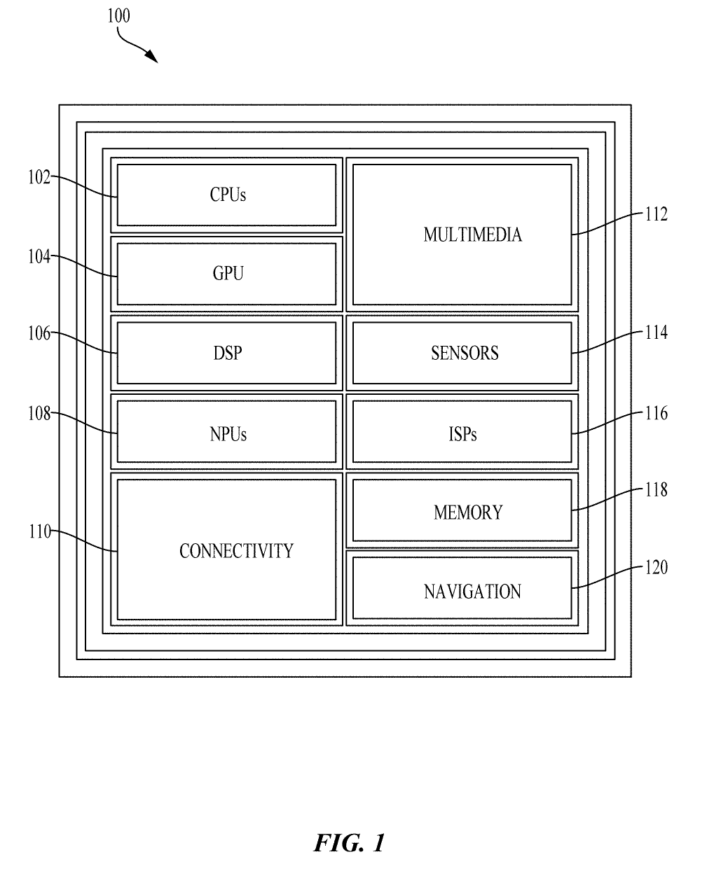

FIG. 1 illustrates an example implementation of the aforementioned method of computation in a deep neural network using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, fifth generation wireless system (5G) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code to discretize a first input signal and a second input signal. The instructions loaded into the general-purpose processor 102 may also comprise code to compute a temporal difference of the discrete first input signal and the discrete second input signal to produce a discretized temporal difference. In addition, the instructions loaded into the general-purpose processor 102 may comprise code to apply weights of a first layer of the deep neural network to the discretized temporal difference to create an output of a weight matrix. The instructions loaded into the general-purpose processor 102 may further comprise code to temporally sum the output of the weight matrix with a previous output of the weight matrix. Furthermore, the instructions loaded into the general-purpose processor 102 may also comprise code to apply an activation function to the temporally summed output to create a next input signal to a next layer of the deep neural network.

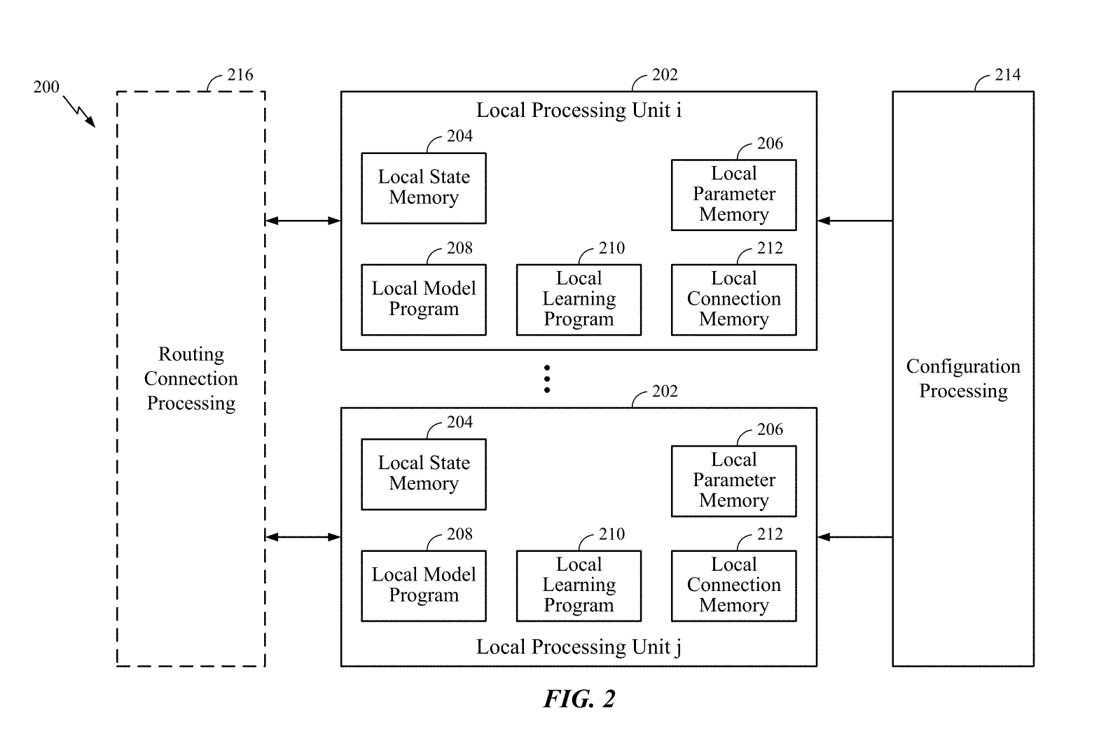

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

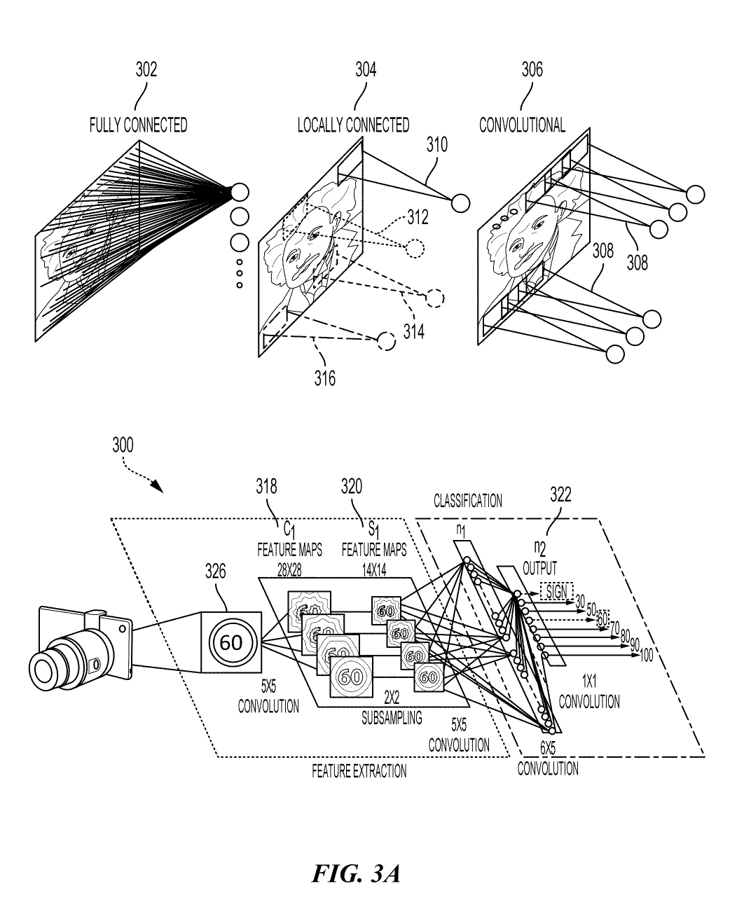

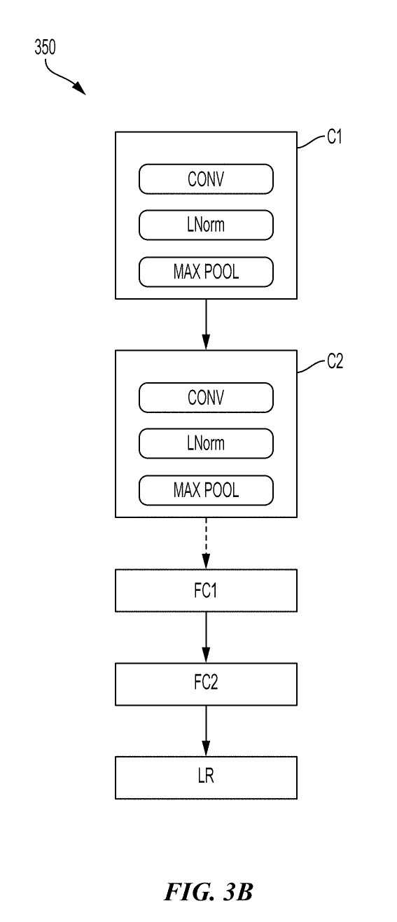

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

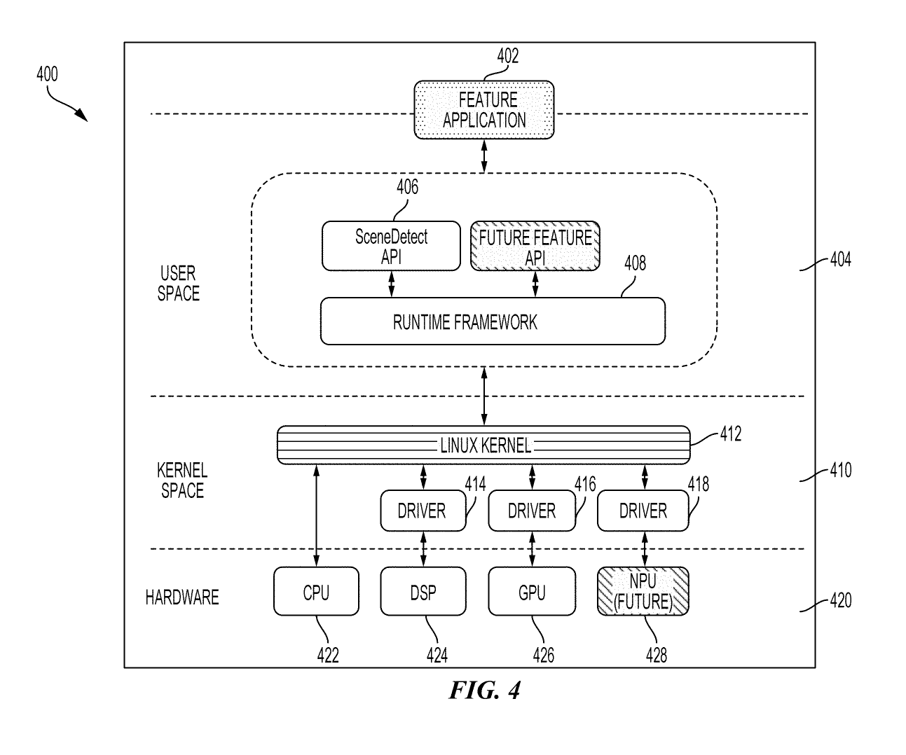

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

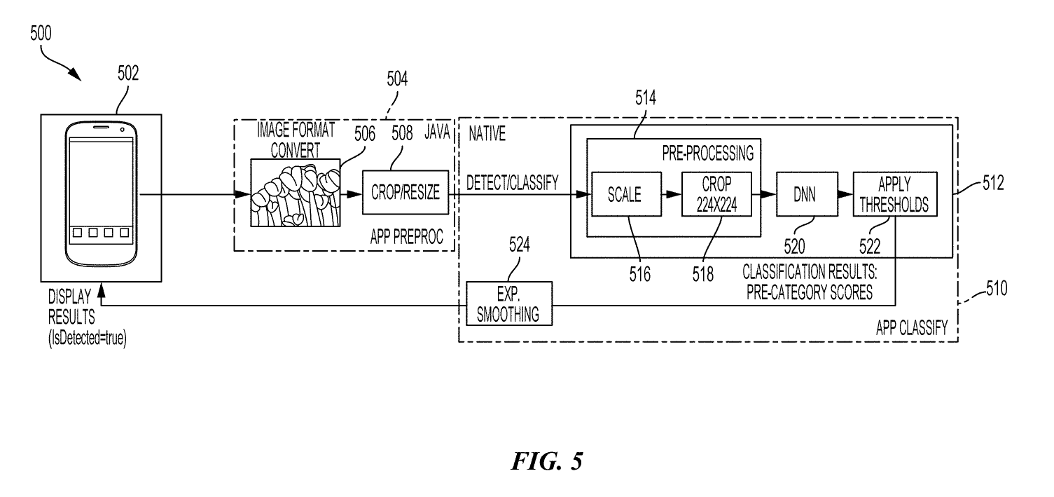

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

### Temporal Difference Estimation in an Artificial Neural Network

Aspects of the present disclosure are directed to configuring an artificial neural network as a Sigma-Delta network which may also be referred to as a Sigma Delta quantized network. The deep neural network configured as a Sigma-Delta network may take advantage of the similarities between successive portions (e.g., frames) of sequential data. Instead, of processing each new input (e.g. a portion of sequential data) with a full forward pass at each layer of the neural network, the Sigma-Delta network sends a discretized form of the differences in activation to a next layer of the network for each new input. A forward pass of a neural network may be expressed as a composition of subfunctions: ƒ(x)=(ƒ_{L}∘ . . . ∘ƒ₂∘ƒ₁)(x), where x is the input. Thus, by passing discretized differences, the amount of computation performed by the network scales with the amount of change in the input and layer activations, rather than the size of the network.

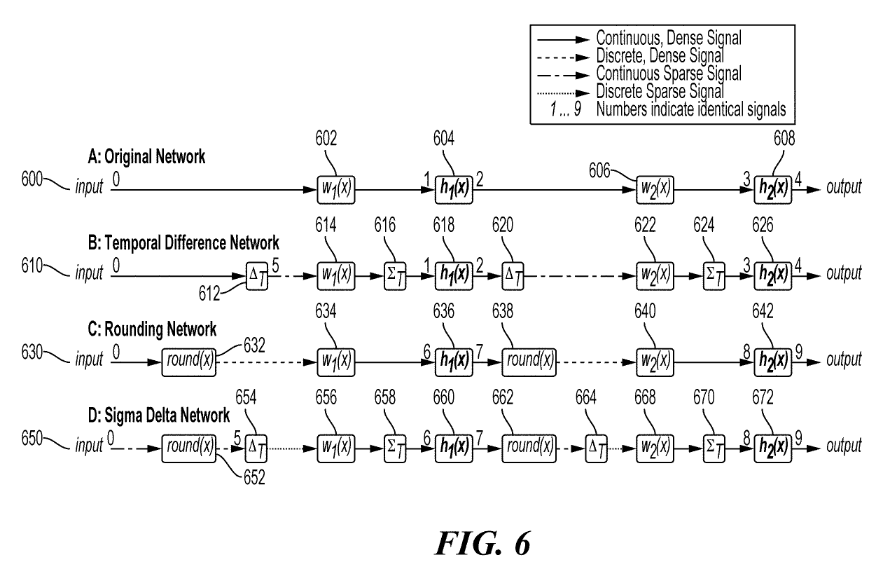

FIG. 6 is a block diagrams illustrating exemplary neural network architectures in accordance with aspects of the present disclosure. Referring to FIG. 6, a standard deep neural network 600 is shown. The deep neural network 600 includes an alternating sequence of weight matrix modules (w(x)) (e.g., 602, 606) and non-linear transform modules (h(x)) (e.g., 604, 608). The application of each of the alternating modules produces a continuous dense signal. The matrix multiplication operations and convolution operations result in numerous computations, which may be costly.

FIG. 6 also illustrates a neural network configured as a temporal difference network 610. The temporal difference network 610, like the deep neural network 600 includes a sequence of weight matrix modules (w(x)) (e.g., 614, 622) and non-linear transform modules (h(x)) (e.g., 618, 626). However, rather than operating on the input at each module, the temporal difference network 610 communicates differences in activation between layers. That is, the temporal difference network 610 is further configured with temporal difference modules (Δ_{T}) (612, 620) and temporal integration modules (Σ_{T}) (616, 624). The temporal difference modules (612, 620) compute a temporal difference between successive inputs (e.g., a frame of a video sequence). The temporal difference is then supplied to the weight matrix module (e.g., 614) and a weight matrix is applied to the temporal difference. The output of the weight matrix module (e.g., 614) is supplied to the temporal integration module (e.g., 616). The temporal integration module (e.g., 616) computes a temporal sum of the weight matrix module outputs. The temporal sum is, in turn supplied to the non-linear transform module (e.g., 618), which applies an activation function to the temporal sum. The output of the nonlinear transform module (e.g., 618) is supplied to the next layer of the temporal difference network, which repeats the process.

By way of example and explanation, tables 1 and 2 include processes for determining a temporal difference (Δ_{T}) and a temporal integration (Σ_{T}).

TABLE 1
Temporal Difference (Δ_{T}):

1: Internal: \vec{x}ₗₐₛₜ ϵ [symbol] ^{d} ← \vec{0}
2: Input: \vec{x} ϵ [symbol] ^{d}
3: \vec{y} ← \vec{x} − \vec{x}ₗₐₛₜ
4: \vec{x}ₗₐₛₜ ← \vec{x}
5: Return: \vec{y} ϵ [symbol] ^{d}

TABLE 2
Temporal Integration (Σ_{T}):

1: Internal: \vec{y} ϵ [symbol] ^{d} ← \vec{0}
2: Input: \vec{x} ϵ [symbol] ^{d}
3: \vec{y} ← \vec{y} + \vec{x}
4: Return: \vec{y} ϵ [symbol] ^{d}

When presented with a sequence of inputs x₁, . . . xₜ, Δ_{T}(xₜ)=xₜ−xₜ₋₁|ₓ_{₀}₌₀, and Σ_{T}(xₜ)=Σ_{τ=1}^{t}x_{τ}. The “temporal differences” do not refer to the change in the signal over time, but rather the change between two inputs presented sequentially. That is, the output of the neural network may only depend on the value and order of inputs, rather than on the temporal spacing between them.

Because Σ_{T}(Δ_{T}(xₜ,))=xₜ, the temporal difference/temporal integration pairs (Σ_{T}^{∘}Δ_{T}) may be inserted into the network without affecting the network function. Thus, the network function (e.g., forward pass) may be expressed as: ƒ(x)=(ƒ_{L}∘Σ_{T}∘Δ_{T}∘ . . . ∘ƒ₂∘Σ_{T}∘Δ_{T}∘ƒ₁∘Σ_{T}∘Δ_{T})(x).

If the neural network comprises alternating linear functions (e.g., weight matrix ω(x)), and nonlinear functions (e.g., non-linear transform function h(x)), the network function (e.g., forward pass) may be given by ƒ(x)=(h_{L}^{∘}ω_{L} . . . ^{∘}h₂^{∘}ω₂^{∘}h₁^{∘}ω₁)(x). As before, the temporal difference/temporal integration pairs Σ_{T}∘Δ_{T} may be inserted into the network function. For a linear function (e.g., weight matrix ω(x)), the operations of computing the temporal integration, apply the weight matrix (e.g., matrix multiplication) and computing the temporal difference (Σ_{T}, ω, Δ_{T}) all commute with one another. That is:

Δ_{T}(ω(Σ_{T}(x)))=ω(Δ_{T}(Σ_{T}(x)))=ω(x) (1)

Therefore, substituting Δ_{T}^{∘}ω^{∘}Σ_{T} with ω, yields ƒ(x)=(h_{L}^{∘}Σ_{T}^{∘}ω_{L}^{∘} . . . ^{∘}Δ_{T}^{∘}h₂^{∘}Σ_{T}^{∘}ω₂^{∘}Δ_{T}^{∘}h₁^{∘}Σ_{T}^{∘}ω₁^{∘}Δ_{T})(x).

FIG. 6 further illustrates a neural network configured as a rounding network 630. The rounding network 630 is also similar to the deep neural network 600 shown in FIG. 6. The rounding network 630 includes a sequence of weight matrix modules (w(x)) (e.g., 634, 640) and non-linear transform modules (h(x)) (e.g., 636, 642). However, the rounding network 630 communicates an approximation of activations between layers. That is, as shown in FIG. 6, a round module (e.g., 632, 638) applies a rounding function to round the input signals and discretizes the activations, which are sent to subsequent layers. The rounding network 630 rounds the activations at every layer before sending the difference between rounded activations to the next layer. By applying the rounding function, a discrete dense signal is supplied to each subsequent layer resulting in fewer computations.

FIG. 6 additionally illustrates a neural network configured as a Sigma-Delta network 650 in accordance with aspects of the present disclosure. The Sigma-Delta network 650 also includes alternating weight matrix modules (w(x)) (e.g., 656, 668) and non-linear transform modules (h(x)) (e.g., 660, 672). The Sigma-Delta network 650 combines many of the features of the temporal difference network 610 and the rounding network 630. That is, the Sigma-Delta network 650 includes rounding modules (e.g., 652, 662), as well as temporal difference modules (654, 664) and temporal integration modules (658, 670). In the Sigma-Delta network 650, the temporal differences are discretized by applying a rounding function via the rounding module (e.g., 652) before computing the temporal difference.

When dealing with data that is spatio-temporally redundant, like a video, the output of the temporal difference modules (Δ_{T)} may comprise a vector with low values (e.g., values near zero), with some peaks corresponding to temporal transitions at certain input positions. The data may have this property not only at the input layer (e.g., first layer), but even more so at higher layers, which encode higher level features (edges, object parts, class labels). Using the spatio-temporal difference rather than pixel difference may be beneficial because the temporal difference values may vary more slowly over time than pixel values. Taking the temporal difference may produce a vector in which the low values from one input to the next essentially cancel each other, leaving the peak values. As such, this “peaky” vector of temporal differences may be discretized to produce a sparse vector of integers, which can then be used to communicate the approximate change in the state of a layer to its subsequent or downstream layer(s) of the neural network.

The temporal difference may be discretized by applying a rounding function before the temporal-difference operation. That is, the activation values may be rounded. The temporal differences of these rounded values may then be supplied to subsequent layers of the neural network. The temporal difference of the rounded activations may be given by:

Σ_{T}(ω(Δ_{T}(round(x))))=ω(Σ_{T}(Δ_{T}(round(x))))=ω(round(x)) (2)

In some aspects, the temporal difference may be discretized by applying a herding function as shown in tables 3 and 4, for example.

TABLE 3
Herding

1: Internal: \vec{Ø} ϵ [symbol] ^{d} ← \vec{0}
2: Input: \vec{x}ₜ ϵ [symbol] ^{d}
3: \vec{Ø} ← Ø + \vec{x}ₜ
4: \vec{s} ← round (\vec{Ø})
5: \vec{Ø} ← \vec{Ø} − \vec{s}
6: Return: \vec{s} ϵ [symbol] ^{d}

TABLE 4
Delta-Herding

1: Internal: \vec{s}ₗₐₛₜ ϵ [symbol] ^{d} ← \vec{0}
2: Input: xₜ ϵ [symbol] ^{d}
3: \vec{s} ← round (xₜ)
4: Δ\vec{s} ← \vec{s} − \vec{s}ₗₐₛₜ
5: \vec{s}ₗₐₛₜ ← \vec{s}
6: Return: Δ\vec{s} ϵ [symbol] ^{d}

### Sparse Dot Product

A significant portion of the computations in neural networks (e.g., deep neural networks) is consumed performing matrix multiplication and convolution operations. In some aspects, the amount of computation may be reduced by translating the input to these operations into an integer array with a small L1 norm, for example.

With sparse, low-magnitude integer input, a vector-matrix dot product may be computed efficiently by decomposing the vector-matrix dot product into a sequence of vector additions. This may be observed by decomposing the vector \vec{x}ϵ [symbol] ^{d}^{ᵢₙ} into a set of indices [symbol] (iₙ, sₙ): iϵ└1 . . . len(\vec{x})┘, sϵ±1, n=└ . . . N┘ [symbol] , such that \vec{x}=Σₙ₌₁^{N}, sₙ \vec{e}ᵢ_{ₙ}, where eᵢ_{ₙ} is a one-hot vector with element iₙ hot, N=|\vec{x}|_{L1} is the total L1 magnitude of the vector, and len is the number of elements (length) of a vector. In turn, the dot-product may be computed as a series of additions, as shown in Equation 3:

$$u = \vec{x} \cdot W : W ∈ {ℝ}^{{d}_{in} {xd}_{out}} = ( {\sum }_{n = 1}^{N} {s}_{n} {\vec{e}}_{{i}_{n}} ) \cdot W = {\sum }_{n = 1}^{N} {\vec{s}}_{n} {e}_{{i}_{n}} \cdot W = {\sum }_{n = 1}^{N} {s}_{n} \cdot {W}_{{i}_{n ,}} \qquad ( 3 )$$

Computing the dot product in this manner takes N·dₒᵤₜ additions. In contrast, a normal dense dot-product takes dᵢₙ·dₒᵤₜ multiplications and (dᵢₙ−1)·dₒᵤₜ additions.

In accordance with exemplary aspects of the present disclosure, existing pre-trained networks may be configured as Sigma-Delta networks. In configuring an existing pre-trained network as a Sigma-Delta network, two competing objectives are: (1) error (e.g., with respect to a non-quantized forward pass), and (2) computation—the number of additions performed in a forward pass.

In some aspects, the trade-off may be controlled between the competing objectives by changing the scale of discretization. In one example, the rounding function may be extended by adding a scale term kϵ [symbol] ⁺:

round(\vec{x},k)≡round(\vec{x}·k)/k (4)

This scale may be added layerwise or unitwise (e.g., vector of scales per layer). Higher k values may produce higher precision, but may also use more computation. The network functions incorporating the scale term become:

$$\begin{matrix} {f}_{round} ( x ) = ( {h}_{L}^{∘} \frac{{ω}_{L}}{{k}_{L}} {}_{ }^{∘}{round}{}_{ }^{∘} \cdot {k}_{L}^{∘} … { }_{ }^{∘} {{h}_{1}}_{ }^{∘} \frac{{ω}_{1}}{{k}_{1}} {}_{ }^{∘}{round}{}_{ }^{∘} \cdot {k}_{1} ) ( x ) & ( 5 ) \\ {f}_{\sum Δ} ( x ) = ( {h}_{L}^{∘} {\sum }_{T}^{∘} \frac{{ω}_{L}}{{k}_{L}} {}_{ }^{∘}{round}{}_{ }^{∘} {k}_{L}^{∘} {Δ}_{T}^{∘} … {{}_{ }^{∘}{h}{}_{1}^{}}_{ }^{∘} {\sum }_{T}^{∘} \frac{{ω}_{1}}{{k}_{1}} {}_{ }^{∘}{round}{}_{ }^{∘} \cdot {k}_{1}^{∘} {Δ}_{T} ) ( x ) & ( 6 )\end{matrix}$$

By adjusting these scales kₗ, the tradeoff between computation and error can be manipulated. Alternatively, in some aspects, rectifier linear unit (ReLU) activation functions may be used.

In some aspects, an optimization process may be performed to balance the competing objectives for the rounding network (Network 630 in FIG. 6). For instance, the loss may be defined as follows:

$$\begin{matrix}{ℒ}_{error} = 𝒟 ( {f}_{round} ( x ) , {f}_{true} ( x ) ) & ( 7 ) \\ {ℒ}_{comp} = {\sum }_{l = 1}^{L - 1} {\vert {s}_{1} \vert}_{L 1} {d}_{l + 1} & ( 8 ) \\ {ℒ}_{total} = {ℒ}_{error} + {λℒ}_{comp} & ( 9 )\end{matrix}$$

where [symbol] (a, b) is some scalar distance function (e.g., KL-divergence for softmax output layers or L2-norm), ƒ_{round}(x) is the output of the rounding network 630, and ƒₜᵣᵤₑ(x) is the output of the neural network 600 in FIG. 6 and [symbol] is the computational loss, defined as the total number of additions required in a forward pass. Each layer performs |s₁|_{L1}dₗ₊₁ additions, where s₁ is the discrete output of the l'th layer, dₗ₊₁ is the dimensionality of the (l+1)'th layer and λ is the tradeoff parameter balancing the importance of the two losses.

The rounding network output y=round(k·x) is not be differentiable with respect to the scale, k, or the input, x. However, on the backward pass through the neural network (e.g., in back propagation), when computing the gradient with respect to the error

$$\frac{\partial {L}_{comp}}{\partial {k}_{1}} ,$$

the gradient may be passed through all rounding operations in the backward pass for layers [l+1, . . . , L]. Due to instabilities that may arise when computing

$$\frac{\partial {ℒ}_{comp , {1}^{′}}}{\partial {k}_{1}}$$

where l′>l, the gradient of the computation cost with respect to the scale parameter of layer l may be approximated as

$$\frac{\partial {ℒ}_{error}}{\partial {k}_{1}} \approx \frac{\partial {ℒ}_{comp , 1}}{\partial {k}_{1}} .$$

In one configuration, a neural network model is configured for discretizing a first input signal and a second input signal and for computing a temporal difference of the discrete first input signal and the discrete second input signal. The neural network model is also configured for applying weights of a first layer of the deep neural network to the discretized temporal difference to create an output of the weight matrix. Additionally, the neural network model is configured for temporally summing the output of the weight matrix with a previous output of the weight matrix and for applying an activation function to the temporally summed output to create a next input signal to a next layer of the deep neural network. The model includes means for discretizing, means for computing, means for applying weights, means for temporally summing, and/or means for applying an activation function. In one aspect, the computing means, discretizing means, means for applying weights, means for temporally summing, and/or means for applying an activation function may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

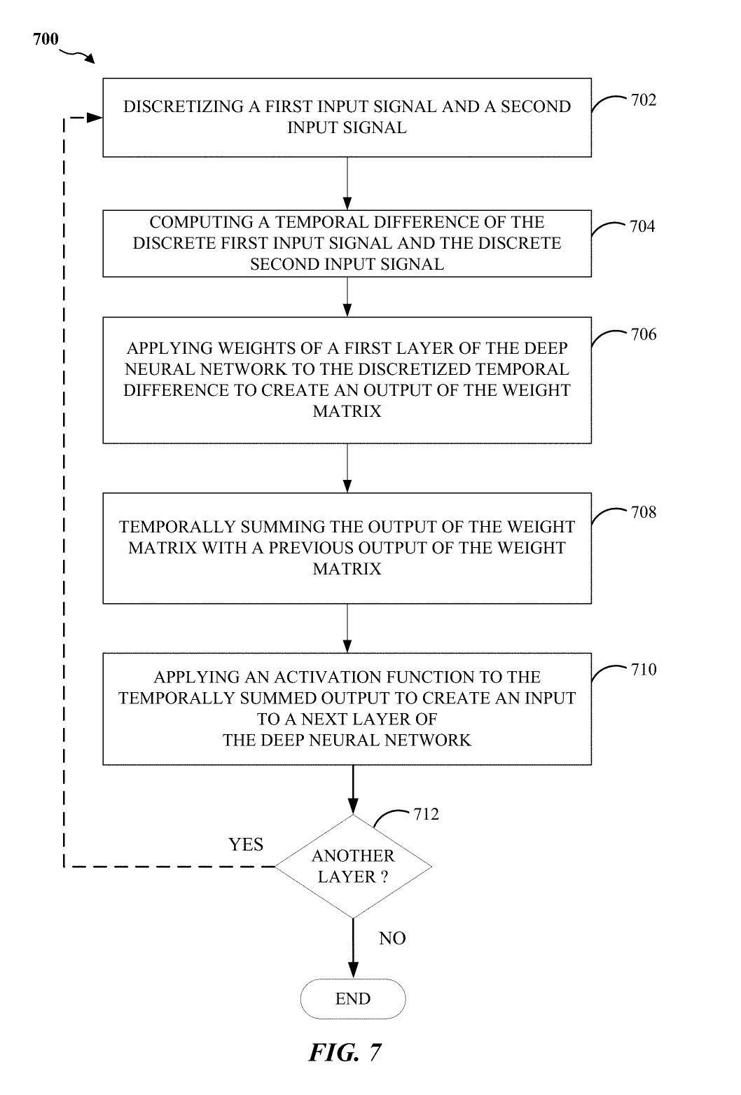

FIG. 7 illustrates a method 700 of computation in a deep neural network. In block 702, the process discretizes a first input signal and a second input signal. In some aspects, the input signals may be discretized, for example, by applying a rounding process or a herding process to the input signals. For instance, as shown in FIG. 6, a round module (e.g., 632, 638) applies a rounding function to round the input signals and discretize the activations, which are sent to subsequent layers of the deep neural network. By applying the rounding function, a discrete dense signal is supplied to each subsequent layer resulting in fewer computations.

In block 704, the process computes a temporal difference of the discrete first input signal and the discrete second input signal to produce a discretized temporal difference. Temporal difference modules (e.g., 654, 664 of FIG. 6) may compute the difference between rounded inputs (or activations to a next layer) and supply the difference to a subsequent layer of the deep neural network.

In block 706, the process applies weights of a first layer of the deep neural network to the discretized temporal difference to create an output of a weight matrix. In some aspects, the output may comprise a real vector. The real vector may correspond to an approximation of extracted visual features, for example. In another example, the real vector may correspond to an approximation of classification results.

In block 708, the process temporally sums the output of the weight matrix with a previous output of the weight matrix. Furthermore, in block 710, the process applies an activation function to the temporally summed output to create a next input signal to a next layer of the deep neural network. For instance, as shown in FIG. 6, a temporal integration module (e.g., 658, 670) may compute a temporal sum of the weight matrix module outputs. The temporal sum is, in turn supplied to the non-linear transform module (e.g., 660, 672), which applies an activation function to the temporal sum. The output of the nonlinear transform module (e.g., 660, 672) is supplied to the next layer of the deep neural network.

Furthermore, in block 712, the process determines if the temporally summed output is to be passed to another layer. For example, this determination may be based on whether the output layer has been reached. If the output layer has not been reached, the process may return to block 702 to repeat the process steps at each subsequent layer of the neural network to generate a network output (e.g., y(t)). On the other hand, if the output layer has been reached, the process may end.

In some aspects, method 700 may be performed by the SOC 100 (FIG. 1) or the system 200 (FIG. 2). That is, each of the elements of method 700 may, for example, but without limitation, be performed by the SOC 100 or the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of computation in a deep neural network, comprising:
discretizing a first input signal and a second input signal;
computing a temporal difference of the discrete first input signal and the discrete second input signal to produce a discretized temporal difference;
applying weights of a first layer of the deep neural network to the discretized temporal difference to create an output of a weight matrix;
temporally summing the output of the weight matrix with a previous output of the weight matrix; and
applying an activation function to the temporally summed output to create a next input signal to a next layer of the deep neural network.

2. The method of claim 1, further comprising:
discretizing the next input signal;
computing a second temporal difference of the discrete next input signal and a previous discrete input to the next layer to produce a discretized second temporal difference;
applying weights of the next layer of the deep neural network to the discretized second temporal difference to create a second output of the weight matrix;
temporally summing the second output of the weight matrix with the previous output of the weight matrix to produce a second summed output; and
applying the activation function to the second summed output to create a subsequent input signal to a subsequent layer of the deep neural network.

3. The method of claim 1, in which the temporally summed output comprises a real vector corresponding to an approximation of extracted visual features.

4. The method of claim 1, in which the temporally summed output comprises a real vector corresponding to an approximation of classification results.

5. The method of claim 1, in which the discretizing comprises applying a herding process to the first input signal and the second input signal.

6. The method of claim 1, in which the discretizing comprises rounding the first input signal and the second input signal.

7. An apparatus for computation in a deep neural network, comprising:
a memory; and
at least one processor coupled to the memory, the at least one processor configured:
to discretize a first input signal and a second input signal;
to compute a temporal difference of the discrete first input signal and the discrete second input signal to produce a discretized temporal difference;
to apply weights of a first layer of the deep neural network to the discretized temporal difference to create an output of a weight matrix;
to temporally sum the output of the weight matrix with a previous output of the weight matrix; and
to apply an activation function to the temporally summed output to create a next input signal to a next layer of the deep neural network.

8. The apparatus of claim 7, in which the at least one processor is further configured:
to discretize the next input signal;
to compute a second temporal difference of the discrete next input signal and a previous discrete input to the next layer to produce a discretized second temporal difference;
to apply weights of the next layer of the deep neural network to the discretized second temporal difference to create a second output of the weight matrix;
to temporally sum the second output of the weight matrix with the previous output of the weight matrix to produce a second summed output; and
to apply the activation function to the second summed output to create a subsequent input signal to a subsequent layer of the deep neural network.

9. The apparatus of claim 7, in which the temporally summed output comprises a real vector corresponding to an approximation of extracted visual features.

10. The apparatus of claim 7, in which the temporally summed output comprises a real vector corresponding to an approximation of classification results.

11. The apparatus of claim 7, in which the at least one processor is further configured to discretize the input signal by applying a herding process to the input signal.

12. The apparatus of claim 7, in which the at least one processor is further configured to discretize the input signal by rounding the input signal.

13. An apparatus for computation in a deep neural network, comprising:
means for discretizing a first input signal and a second input signal;
means for computing a temporal difference of the discrete first input signal and the discrete second input signal to produce a discretized temporal difference;
means for applying weights of a first layer of the deep neural network to the discretized temporal difference to create an output of a weight matrix;
means for temporally summing the output of the weight matrix with a previous output of the weight matrix; and
means for applying an activation function to the temporally summed output to create a next input signal to a next layer of the deep neural network.

14. The apparatus of claim 13, further comprising:
means for discretizing the next input signal;
means for computing a second temporal difference of the discrete next input signal and a previous discrete input to the next layer to produce a discretized second temporal difference;
means for applying weights of the next layer of the deep neural network to the discretized second temporal difference to create a second output of the weight matrix;
means for temporally summing the second output of the weight matrix with the previous output of the weight matrix to produce a second summed output; and
means for applying the activation function to the second summed output to create a subsequent input signal to a subsequent layer of the deep neural network.

15. The apparatus of claim 13, in which the temporally summed output comprises a real vector corresponding to an approximation of extracted visual features.

16. The apparatus of claim 13, in which the temporally summed output comprises a real vector corresponding to an approximation of classification results.

17. The apparatus of claim 13, in which the means for discretizing discretizes the first input signal and the second input signal by applying a herding process to the first input signal and the second input signal.

18. The apparatus of claim 13, in which the means for discretizing discretizes the first input signal and the second input signal by rounding the first input signal and the second input signal.

19. A non-transitory computer readable medium having encoded thereon program code for computation in a deep neural network, the program code being executed by a processor and comprising:
program code to discretize a first input signal and a second input signal;
program code to compute a temporal difference of the discrete first input signal and the discrete second input signal to produce a discretized temporal difference;
program code to apply weights of a first layer of the deep neural network to the discretized temporal difference to create an output of a weight matrix;
program code to temporally sum the output of the weight matrix with a previous output of the weight matrix; and
program code to apply an activation function to the temporally summed output to create a next input signal to a next layer of the deep neural network.

20. The non-transitory computer readable medium of claim 19, further comprising:
program code to discretize the next input signal;
program code to compute a second temporal difference of the discrete next input signal and a previous discrete input to the next layer to produce a discretized second temporal difference;
program code to apply weights of the next layer of the deep neural network to the discretized second temporal difference to create a second output of the weight matrix;
program code to temporally sum the second output of the weight matrix with the previous output of the weight matrix to produce a second summed output; and
program code to apply the activation function to the second summed output to create a subsequent input signal to a subsequent layer of the deep neural network.

21. The non-transitory computer readable medium of claim 19, in which the temporally summed output comprises a real vector corresponding to an approximation of extracted visual features.

22. The non-transitory computer readable medium of claim 19, in which the temporally summed output comprises a real vector corresponding to an approximation of classification results.

23. The non-transitory computer readable medium of claim 19, further comprising program code to discretize the first input signal and the second input signal by applying a herding process to the first input signal and the second input signal.

24. The non-transitory computer readable medium of claim 19, further comprising program code to discretize the first input signal and the second input signal by rounding the first input signal and the second input signal.
